(19) United States
(12) Patent Application Publication
(10) Pub. No.: US 2024/0375489 A1
(43) Pub. Date: Nov. 14, 2024

(54) METHOD, OUTLET ELEMENT, AND SYSTEM FOR THE DIRECTED EMISSION OF A FRAGRANCE

(71) Applicant: Ford Global Technologies, LLC, Dearborn, MI (US)

(72) Inventors: Rainer Vogt, Aachen (DE); Marcel Mathissen, Übach-Palenberg (DE); Volker Scheer, Roetgen (DE); Julius Maximilian Engelke, Aachen (DE)

(73) Assignee: Ford Global Technologies, LLC, Dearborn, MI (US)

(21) Appl. No.: 18/628,961

(22) Filed: Apr. 8, 2024

(30) Foreign Application Priority Data
May 8, 2023 (DE) 102023111925.7

(51) Int. Cl. B60H 3/00; B60H 1/00; B60H 1/34

(52) U.S. Cl. CPC B60H 3/0028; B60H 1/00735; B60H 1/3421; B60H 3/0035

(57) ABSTRACT

A method for a directed emission of a fragrance, comprising mixing a first stream of air with the fragrance, emitting the first stream of air from an outlet element, and emitting a second stream of air, which is not mixed with the fragrance, in the form of a laminar flow from the outlet element, wherein the emission of the second stream of air takes place at the same time as the emission of the first stream of air, and wherein the second stream of air is emitted from the outlet element in an arrangement enclosing the first stream of air such that the second stream of air forms a laminar enveloping flow of the first stream of air after the emission from the outlet element. Also included is an outlet element and a system for the directed emission of a fragrance.

### CROSS-REFERENCE TO RELATED APPLICATION

This application claims foreign priority benefits under 35 U.S.C. § 119 (a)-(d) to German Application No. 102023111925.7 filed May 8, 2023, which is hereby incorporated by reference in its entirety.

### FIELD OF THE DISCLOSURE

The present disclosure generally relates to a method for the directed emission of a fragrance, and moreover relates to an outlet element which can be used for the directed emission of a fragrance and a system for the directed emission of a fragrance.

### BACKGROUND OF THE DISCLOSURE

It can be desirable for the air in a space, for example a vehicle interior, to be mixed with a fragrance. For example, fragrances can be fed into the vehicle interior via a ventilation system. It is moreover possible that perfume atomizers may be arranged in the vehicle interior. The fragrance is thus distributed more or less uniformly in the vehicle interior. Consequently, the fragrance may be noticed by vehicle occupants who have not requested it to be distributed or who may not want the fragrance. Furthermore, typically a relatively large amount of fragrance has to be fed into the vehicle interior for it to be noticeable.

It would be desirable to provide a method and apparatus by which a fragrance can be conveyed into a locally restricted area in a targeted fashion, particularly in which a relatively small amount of fragrance is needed.

### SUMMARY OF THE DISCLOSURE

According to a first aspect of the present disclosure, a method for a directed emission of a fragrance, comprising mixing a first stream of air with the fragrance, emitting the first stream of air from an outlet element, and emitting a second stream of air, which is not mixed with the fragrance, in a form of a laminar flow from the outlet element, wherein the emission of the second stream of air takes place at the same time as the emission of the first stream of air, and wherein the second stream of air is emitted from the outlet element in an arrangement enclosing the first stream of air such that the second stream of air forms a laminar enveloping flow of the first stream of air after the emission from the outlet element.

Embodiments of the first aspect of the present disclosure can include any one or a combination of the following features:
the first stream of air is emitted from the outlet element in a direction of flow parallel to the second stream of air;
the second stream of air has, after the emission from the outlet element, a larger cross-sectional surface area, perpendicular to a direction of flow of the first stream of air and the second stream of air, than the first stream of air;
the emission of the first stream of air and the second stream of air takes place about a common center point;
a process-controlled perfuming procedure which is triggered by at least one user input, a sensor or data value, and/or a request from a video game;
the sensor or data value is selected from the group consisting of an output value of an electronic nose, a camera signal, an audio signal, and a GPS signal;
calculating situation-dependent fragrance settings on the basis of the at least one user input, the sensor or data value, the request from the video game, and/or on the basis of vehicle measurement data;
a point in time at which the mixing of the first stream of air with the fragrance begins, a point in time at which the mixing of the first stream of air with the fragrance ends, the type of the fragrance, and/or a quantity of the fragrance are fixed depending on the situation-dependent fragrance settings;
calculation of a target coordinate for an olfactory effect;
the target coordinate is determined based on a camera signal, a position of a face deduced from the camera signal, audio signals of a microphone array, a position of a face deduced from the audio signals of the microphone array, and/or a user input;
an actuator acts on the outlet element such that the latter directs the first stream of air and the second stream of air to the target coordinate;
a flow rate of the first stream of air and/or the second stream of air is adjusted depending on the target coordinate;
a start time for generating the first stream of air and/or the second stream of air, an end time for generating the first stream of air and/or the second stream of air, and/or a flow rate of the first stream of air and/or the second stream of air are fixed depending on the situation-dependent fragrance settings; and
the fragrance is emitted into a vehicle interior.

According to a second aspect of the present disclosure, an outlet element for a directed emission of a fragrance, the outlet element comprising a first duct for the guidance of a first stream of air and a second duct for the guidance of a second stream of air, wherein the second duct has one or more air flow devices for generating a laminar flow, wherein the first duct forms a first opening for the issuing of the first stream of air, wherein the second duct forms a second opening for the issuing of the second stream of air, and wherein the second opening is arranged such that it surrounds the first opening.

Embodiments of the second aspect of the present disclosure can include any one or a combination of the following features:
the first duct and the second duct are formed in a region immediately upstream of the first opening and the second opening such that the first stream of air is guided in a direction parallel to the second stream of air in the immediately upstream region;
the first opening and the second opening are arranged about a common center point;
the one or more air flow devices for generating the laminar flow are fins which are oriented parallel to a direction of flow of the second stream of air; and
a portion of the outlet element which has the first opening and the second opening is designed as movable such that an orientation of the first stream of air and the second stream of air can change.

According to a third aspect of the present disclosure, a system for a directed emission of a fragrance, comprising at least one air flow device for generating a first steam of air and/or a second stream of air, a discharge device for mixing the first stream of air with the fragrance, and an outlet element comprising a first duct for the guidance of a first stream of air; and a second duct for the guidance of a second stream of air, wherein the second duct has one or more air flow devices for generating a laminar flow, wherein the first duct forms a first opening for the issuing of the first stream of air, wherein the second duct forms a second opening for the issuing of the second stream of air, and wherein the second opening is arranged such that it surrounds the first opening.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic sectional view of an outlet element for the directed emission of a fragrance;

FIG. 2 is a simulated representation of a first stream of air and a second stream of air at a first point in time;

FIG. 3 is a simulated representation of the first stream of air and the second stream of air at a second point in time;

FIG. 4 is a simulated representation of the first stream of air and the second stream of air at a third point in time; and

FIG. 5 is a flow chart illustrating a method of performing a process-controlled perfuming procedure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

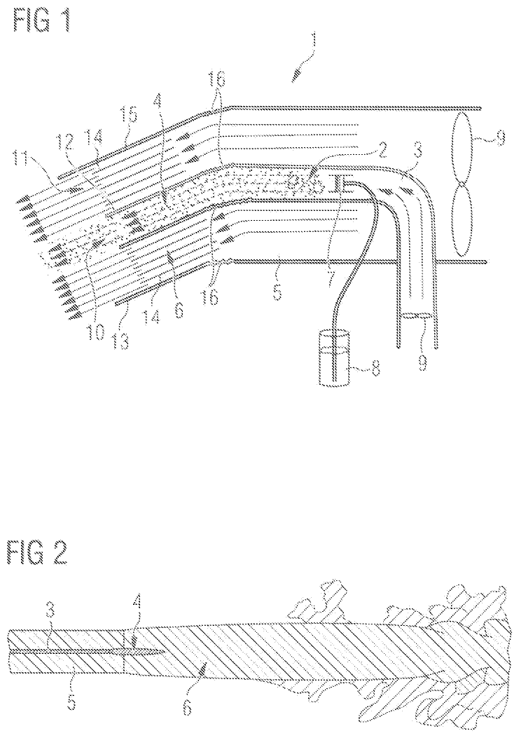

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a method, outlet element, and system for the directed emission of a fragrance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

FIG. 1 shows an outlet element 1 for the directed emission of a fragrance 2 in a sectional view. The outlet element 1 may be located such as installed on a vehicle and used to direct the emission of a fragrance into the vehicle interior via a ventilation system. The outlet element 1 has a first duct 3 for guiding a first stream of air 4 and a second duct 5 for guiding a second stream of air 6. The first duct 3 runs in an end region of the outlet element 1 completely inside the second duct 5 and has a common center point with the latter. A discharge device 7 which discharges the fragrance 2 into the first stream of air 4 is arranged in the first duct 3. The discharge device 7 is a piezoelectric atomizer. The fragrance 2 is fed to the discharge device 7 from an externally arranged container 8. The first stream of air 4 and the second stream of air 6 are generated by ventilators 9 which are arranged in the first duct 3 and the second duct 5.

The first duct 3 forms a first opening 10 of the outlet element 1, from which opening the first stream of air 4, mixed with the fragrance 2, issues. The second duct 5 forms a second opening 11 of the outlet element 1, from which opening the second stream of air 6 issues. A first outer wall 12 of the first duct 3 extends over a slightly shorter distance than a second outer wall 13 of the second duct 5 such that a combined stream of air, formed by the first stream of air 4 and the second stream of air 6, is additionally stabilized. Fins 14 which ensure that the second stream of air 6 forms a laminar flow when it issues from the second opening 11 are arranged in the second duct 5. The second stream of air 6 thus forms a laminar enveloping flow, which encloses the first stream of air 4, after it issues from the outlet element 1. According to the disclosure, targeted discharge of the fragrance 2 over a longer distance is enabled.

An electronic motor such as a 3D actuator, which can orient an end portion 15 of the outlet element 1 in different directions such that the first stream of air 4 or the second stream of air 6 can be directed to a target coordinate, is fastened on the outlet element 1. In order to enable a corresponding orientation of the end portion 15, parts of the outlet element 1 are designed as elastic duct portions 16. The 3D actuator, the discharge device 7, and the ventilators 9 are connected to a computing unit (not illustrated) for the purpose of process control.

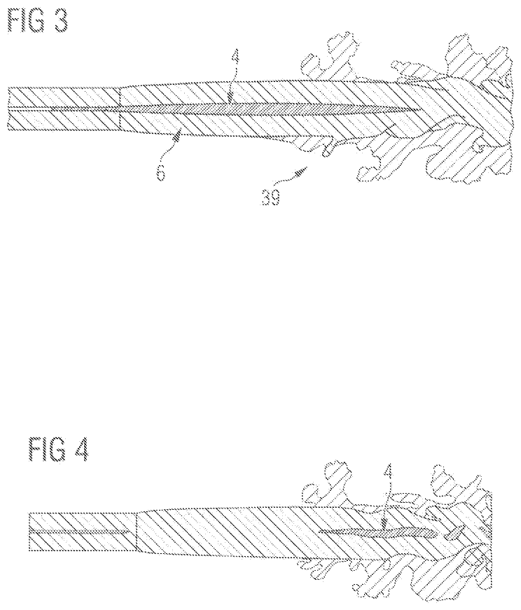

FIG. 2 shows a simulated representation of a first stream of air 4 and a second stream of air 6 at a first point in time. The first stream of air 4 is emitted from a first duct 3 and the second stream of air 6 is emitted from a second duct 5. The first duct 3 has a circular cross-section and the second duct has an annular cross-section. The first duct 3 has an external diameter of 1 cm and an external diameter of the second duct 5 is 15 cm. The second stream of air 6 forms a laminar flow after issuing from the second duct 5. The first stream of air 4 has a flow rate of 2.7 m/s in the first duct 3. The second stream of air 6 has a flow rate of 2.2 m/s in the second duct 5.

FIG. 3 shows a simulated representation of the first stream of air 4 and the second stream of air 6 at a second point in time which is after the first point in time. The discharge of the first stream of air 4 has ended. As can be seen, the first stream of air 4 propagates in a substantially straight line and only to a small degree in a lateral direction. The first stream of air 4 and the second stream of air 6 are illustrated over a distance of 1.5 meters after issuing. As can be seen, first turbulence 39 of the second stream of air 6 occurs after approximately half the distance. The first stream of air 4, which could carry a fragrance, in contrast displays no turbulence.

FIG. 4 shows a simulated representation of the first stream of air 4 and the second stream of air 6 at a third point in time which is after the second point in time. The first turbulence of the first stream of air 4 begins to occur only after a distance of approximately 1.2 meters such that only in a region situated beyond this point is localized deployment of the fragrance is no longer ensured.

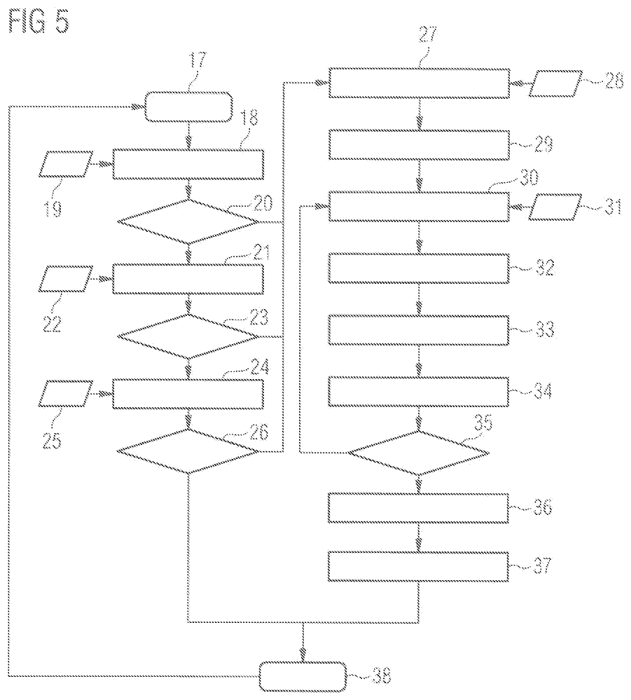

FIG. 5 shows a flow chart of a process-controlled perfuming procedure. It should be understood that all the successive steps can be carried out by a computing unit. The sequence described here should be understood purely by way of example; when executed in practice, steps may be omitted, their order may be changed, and/or they may be executed simultaneously.

A start terminal 17 marks the beginning of the perfuming procedure. A first read process 18 takes place in which a user input 19 is read. The user input 19 can be, for example, pressing a button, a voice command, or another kind of input. In a first checking step 20, the user input 19 is evaluated and a decision is accordingly made as to whether a fragrance is to be discharged. If no fragrance is to be discharged, a second read process 21 takes place. Sensor and/or data values 22 are read in the second read process 21. The sensor and/or data values can comprise an output value of an electronic nose, a camera signal, an audio signal, and/or a GPS signal. The sensor and/or data values 22 are evaluated in a second checking step 23. A decision is made based thereon as to whether the fragrance is then to be discharged.

If a fragrance is to be discharged, a third read process 24 takes place. A request 25 can here be read from a video game. The request 25 is evaluated in a third checking step 26 and, depending thereon, a determination made as to whether the fragrance is to be discharged. If so, situation-dependent fragrance settings are first fixed in an adjustment step 27. The situation-dependent fragrance settings are fixed on the basis of vehicle data 28, the user input 19, the sensor and/or data values 22, and/or the request 25. In a subsequent time-adjustment step 29, a value is fixed in a timer and the timer is started. The value is defined on the basis of the situation-dependent fragrance settings.

A target coordinate for an olfactory effect is then calculated in a target step 30. This takes place on the basis of target data 31. The target data 31 can comprise a camera signal, audio signals of a microphone array, and/or a user input. In an orientation step 32, an actuator is adjusted such that an outlet element is directed toward the target coordinate. In a flow-adjustment step 33, a flow rate of a first stream of air and/or the second stream of air is fixed depending on the target coordinate and/or the fragrance settings. This can be effected, for example, by adjusting at least one ventilator or one valve. The first and/or the second stream of air then flow through the outlet element and issue therefrom in a directed fashion. In a fragrance discharge step 34, discharge of the fragrance into the first stream of air is caused by triggering of an atomizer. A point in time and an intensity of the fragrance discharge are determined depending on the fragrance settings.

In a time checking step 35, a check is made as to whether the value preset in the timer has expired. If the value has not yet expired, the steps 30 to 34 are performed again. If the value has expired, the discharge of the fragrance is stopped in a first cancellation step 36 by the atomizer being deactivated. In a second cancellation step 37, adjustment of at least one ventilator and/or valve takes place such that the first stream of air and the second stream of air again assume a flow rate that they had originally. An end terminal 38 is reached, whereupon the perfuming procedure can, however, begin again by returning to the starting point 17.

According to a first aspect of the disclosure, a method for the directed emission of a fragrance is provided. The method comprises mixing a first stream of air with the fragrance, emitting the first stream of air from an outlet element, and emitting a second stream of air, which is not mixed with the fragrance, in the form of a laminar flow from the outlet element, wherein the emission of the second stream of air takes place at the same time as the emission of the first stream of air, and wherein the second stream of air is emitted from the outlet element in an arrangement enclosing the first stream of air such that the second stream of air forms a laminar enveloping flow of the first stream of air after the emission from the outlet element.

The laminar enveloping flow formed by the second stream of air is constant over a certain distance and serves to guide the first stream of air which is mixed with the fragrance. The fragrance can thus be transported in a targeted fashion over a longer distance in a straight route. In this way, the method according to the disclosure makes it possible to transport the fragrance into a specific area or to the face of a specific person. Also, less fragrance is thus needed. The method can preferably be applied in interior spaces, particularly preferably in a vehicle interior.

A laminar flow within the sense of the present disclosure is understood to mean a gaseous fluid which flows in layers which do not mix with one another. The layers can but do not have to flow at different speeds. A laminar enveloping flow is to be understood within the sense of the present disclosure to mean a laminar flow which encloses or encircles a flow flowing inside it. A cross-section of the first stream of air and the second stream of air, which runs perpendicular to a direction of flow of the second stream of air, shows that the second stream of air surrounds the first stream of air, for example circularly or alternatively in a different surrounding shape.

The first stream of air or the second stream of air is to be understood within the sense of the present disclosure to mean in each case a flowing gaseous mixture. The method can optionally comprise generation of the first stream of air and/or the second stream of air. This can be effected by use of a fan, for example a ventilator, or alternatively in a different manner. It is possible that the first stream of air is generated separately from the second stream of air, for example by the use of two fans. It is alternatively possible that the first and the second stream of air are generated by an output stream of air being generated and separated into the first stream of air and the second stream of air. It is possible that the first stream of air and the second stream of air have a consistent flow rate. Alternatively, however, streams of air with different flow rates can also be used.

The first stream of air and/or the second stream of air can be emitted continuously. It is furthermore possible that a flow rate of the first and/or the second stream of air is adjusted or adapted time-dependently or depending on measurement or data values. Such adjustment or adaptation can be effected by the power of at least one fan, which generates the first and/or the second stream of air, being modified. The adjustment or adaptation can alternatively or additionally take place by use of adaptation of the passage of the first and/or second stream of air through a duct, for example with the aid of a valve.

The first stream of air and the second stream of air are emitted simultaneously in order to enable targeted output of the fragrance. Nevertheless, the emission of the first stream of air can, according to a variant of the disclosure, take place in a pulsed fashion. This means that, at a first point in time only the second stream of air is emitted, at a second point in time the emission of the first stream of air begins such that the first stream of air and the second stream of air are emitted simultaneously, and at a third point in time the emission of the first stream of air ends such that again only the second stream of air is emitted.

The second stream of air is emitted from the outlet element as a laminar flow. The second stream of air thus forms a laminar flow at least outside the outlet element. The second stream of air may form inside the outlet element, i.e. before emission, no laminar flow at all or a laminar flow in just some places. According to possible embodiments of the disclosure, means arranged in the outlet element generate the laminar flow. It is possible but not necessary that the first stream of air arranged inside likewise forms a laminar flow. In such a variant of the disclosure, the first stream of air is thus also emitted from the outlet element as a laminar flow. The first stream of air then forms a laminar flow at least outside the outlet element. In such an embodiment, the first stream of air may form, inside the outlet element, i.e., before emission, no laminar flow at all or a laminar flow in just some places.

It may be advantageous if the first stream of air is emitted from the outlet element in a direction of flow parallel to the second stream of air. Mixing of the first stream of air with the second stream of air is thus counteracted. Parallel emission can be created in particular by use of a suitable geometry of the outlet element.

According to one embodiment, the first stream of air can be mixed with the fragrance by use of an atomizer. The atomizer may be a piezoelectric atomizer. According to other embodiments, the fragrance can, however, also be introduced into the first stream of air in a different fashion. According to various embodiments, the fragrance can be introduced into the first stream of air continuously, periodically, or at specified points in time.

The second stream of air preferably has, after the emission from the outlet element, a larger cross-sectional surface area, perpendicular to a direction of flow of the first stream of air and the second stream of air, than the first stream of air. The first stream of air thus preferably has a rather small diameter, whereas an external diameter of the second stream of air should be relatively large. In the case of a larger cross-sectional surface area of the second stream of air, spreading of the fragrance in the transverse direction to the second stream of air over longer distances is limited. The first stream of air preferably has a circular cross-section after it has issued or at the moment it issues, and the second stream of air has an annular cross-section after it has issued or at the moment it issues. The emission of the first stream of air and the second stream of air preferably takes place about a common center point. A first opening and a second opening of the outlet element, which are provided for the outlet of the first stream of air or the second stream of air, can have a common center point.

According to an advantageous embodiment, the method comprises a process-controlled perfuming procedure which is triggered by user input, a sensor or data value, and/or a request from a video game. The perfuming procedure can be triggered, for example, when a user actuates a switch or gives a voice command. Specific sensor or data values can be monitored and the perfuming procedure started on the basis thereof. A video game can, for example, generate a request in certain game sequences such that fragrances corresponding to the action in the game are emitted. Process control within the sense of the present disclosure is to be understood to mean that the perfuming procedure is influenced and/or controlled according to a sequence schedule or a program, in particular a computer program.

The perfuming procedure can preferably take place with machine assistance, for example assisted by a computing unit such as a computer or a microcontroller. In particular, the computing unit can be an integrated computing unit of a vehicle. It can be connected to sensors and/or actuators of the vehicle. The sensor or data value may be selected from the group consisting of an output value of an electronic nose, a camera signal, an audio signal, and a global positioning system (GPS) signal.

Situation-dependent fragrance settings are preferably calculated on the basis of the at least one user input, the sensor or data value, the request from the video game, and/or on the basis of vehicle measurement data. The situation-dependent fragrance settings can contain parameters for the discharge of the fragrance which are adapted to the situation on the basis of the existing data and information. Thus, according to one embodiment, it is possible to deduce from the user input which fragrance and what intensity of this fragrance is desired. The evaluation of vehicle measurement data enables a wide range of measurement values to be taken into account in the case of a vehicle (for example, speed, driving time, and/or ambient brightness). It can thus, for example, be provided that no fragrance is emitted in certain driving situations. In contrast, a fragrance can be output in other situations. It can thus be provided that a fragrance with a flowery fragrance is discharged when it is calculated that the vehicle is driving through a natural landscape. Situation-dependent discharge of the fragrance is enabled with the aid of the situation-dependent fragrance settings.

It is advantageous if a point in time at which the mixing of the first stream of air with the fragrance begins, a point in time at which the mixing of the first stream of air with the fragrance ends, the type of the fragrance, and/or a quantity of the fragrance are fixed depending on the situation-dependent fragrance settings.

According to a variant, the method can moreover comprise calculation of a target coordinate for an olfactory effect. It consequently needs to be calculated where the olfactory effect is to be generated. The target coordinate at which the olfactory effect is to be created can, for example, then be determined for where a person's nose is situated. The target coordinate can, for example, be a two-dimensional coordinate or a three-dimensional coordinate.

The target coordinate may be determined on the basis of a camera signal, a position of a face deduced from the camera signal, audio signals of a microphone array, a position of a face deduced from the audio signals of the microphone array, and/or a user input. The calculation of the target coordinate preferably takes place by use of a computing unit. A coordinate of a person's mouth can be calculated by use of the evaluation of the audio signals of the microphone array. This coordinate can be used as the target coordinate. Optionally, a position of the person's nose can be deduced from the coordinate of the mouth and employed as the target coordinate.

In the method according to the disclosure, an actuator preferably acts on the outlet element such that the latter directs the first stream of air and the second stream of air to the target coordinate. Emission of the fragrance precisely in the direction of the target coordinate is thus enabled. The actuator can be an electric motor or a different type of motor. In one embodiment, the actuator is a 3D actuator which can change a spatial orientation of the outlet element or a part of the outlet element.

It is to be considered as advantageous if, when the method is carried out, a flow rate of the first stream of air and/or the second stream of air is adjusted depending on the target coordinate. The effect of a fragrance can be amplified specifically in the region of the target coordinate by appropriate adjustment of the flow rate of the first stream of air and/or the second stream of air.

A start time for generating the first stream of air and/or the second stream of air, an end time for generating the first stream of air and/or the second stream of air, and/or a flow rate of the first and/or the second stream of air are fixed depending on the situation-dependent fragrance settings. Accordingly, generation of the first and/or the second stream of air can begin at the start time, or the generation of the first and/or the second stream of air stops at the end time. The flow rate of the first stream of air and/or the second stream of air can be adjusted to a fixed value depending on the situation-dependent fragrance settings but different flow rates can also be fixed for different points in time. With regard to the above explanations, it is the case that the flow rate of the first stream of air and the flow rate of the second stream of air can be adjusted independently of each other.

It should be understood that those method steps described above which relate to process control, regulation, and/or evaluation of data can according to the disclosure be carried out by a computing unit or an electronic process-control and/or regulating system.

According to a further aspect of the disclosure, an outlet element is specified for the directed emission of a fragrance. The outlet element has a first duct for the guidance of a first stream of air and a second duct for the guidance of a second stream of air, wherein the second duct has one or more air flow devices for generating a laminar flow, wherein the first duct forms a first opening for the issuing of the first stream of air, wherein the second duct forms a second opening for the issuing of the second stream of air, and wherein the second opening is arranged such that it surrounds the first opening. If the first and the second stream of air are applied to the outlet element, the second stream of air is then emitted from the outlet element in an arrangement enclosing the first stream of air such that the second stream of air forms a laminar enveloping flow of the first stream of air after emission from the outlet element.

The first duct and the second duct are preferably formed in a region immediately upstream of the first opening and the second opening such that the first stream of air is guided in a direction parallel to the second stream of air in the immediately upstream region. In particular, the first duct and the second duct can be oriented in the immediately upstream region such that the first stream of air is guided in a direction parallel to the second stream of air. It can be achieved in this way that the first stream of air and the second stream of air flow in a parallel direction after emission from the outlet element, which counteracts mixing of the first stream of air with the second stream of air.

The first opening and the second opening are preferably arranged about a common center point. The first opening preferably has a circular cross-section and the second opening preferably has an annular cross-section. According to one embodiment, the first duct can also have a circular cross-section at least in a region adjoining the first opening and/or the second duct can have an annular cross-section.

According to the disclosure, it is possible that the first opening and the second opening are situated at the same height in the direction of flow. It is alternatively possible, but not required, that an outer wall of the second duct extends over a longer distance than an outer wall of the first duct, which can result in additional stabilization of the generated streams of air.

According to an advantageous embodiment, the one or more air flow devices for generating the laminar flow are fins which are oriented parallel to the direction of flow of the second stream of air. The fins split the second stream of air in a large number of laminar layers of air. According to the disclosure, it is also possible that other air flow devices are used to generate the laminar flow.

It can be provided according to the disclosure that a portion of the outlet element which has the first opening and the second opening is designed as movable such that an orientation of the first stream of air and the second stream of air can change. The outlet element preferably has an actuator for modifying the orientation. The actuator can preferably be an electric motor or another type of motor. The actuator is preferably a 3D actuator which can change a spatial orientation of the outlet element or a part of the outlet element. The actuator can act directly or indirectly on the outlet element. According to one possible embodiment, the portion of the outlet element which has the first opening and the second opening has a partially elastic or flexible design such that it is movable or pivotable. An orientation of this portion can be adjusted with the aid of the actuator. It is in particular possible that the portion of the outlet element which has the first opening and the second opening has a tubular shape and guides the first and the second duct.

According to a further aspect of the disclosure, a system for the directed emission of a fragrance is proposed. The system comprises at least an air flow device for generating a first and/or a second stream of air, a discharge device for mixing the first stream of air with the fragrance, and an outlet element. The outlet element is designed as described above. The system is preferably integrated into a vehicle, wherein the outlet element is very particularly preferably arranged in a vehicle interior.

According to the disclosure, the at least one air flow device for generating the first stream of air and/or the second stream of air can be a fan, for example a ventilator, or alternatively another device by use of which a stream of air can be generated. According to the disclosure, it is possible that the system has both a first air flow device for generating the first stream of air and a second air flow device for generating the second stream of air. It is alternatively possible that the system only has an air flow device for generating an output stream of air, wherein the system splits the output stream of air into the first stream of air and the second stream of air. The output stream of air can thus be introduced into a first duct and a second duct, wherein the first duct is provided for guiding the first stream of air and the second duct is provided for guiding the second stream of air. The at least one air flow device for generating the first stream of air and/or the second stream of air can, according to one embodiment, be integrated into the outlet element. It is, however, also possible that the at least one air flow device for generating the first stream of air and/or the second stream of air is arranged outside the outlet element.

The discharge device for mixing the first stream of air with the fragrance is preferably an atomizer and particularly preferably a piezoelectric atomizer. The system can, however, also have an atomizer of another type or a different device which can apply the fragrance to the first stream of air. According to the disclosure, the discharge device can be arranged inside the outlet element. It is, however, alternatively also possible that the discharge device is arranged outside the outlet element.

The system preferably has a computing unit which can undertake the tasks of process control, regulation, and/or evaluation of data which can occur during operation of the system and in particular when the system for carrying out the above-described method is used. The computing unit can here be configured to receive a user input, a sensor or data value, and/or a request from a video game, to evaluate it, to trigger the perfuming procedure depending on the result of the evaluation, to control its sequence, and/or to regulate the latter. The computing unit can moreover be configured to calculate situation-dependent fragrance settings on the basis of the at least one user input, the sensor or data value, the request from the video game, and/or from vehicle measurement data.

The computing unit can in particular be configured to fix a point in time at which the mixing of the first stream of air with the fragrance begins, a point in time at which the mixing of the first stream of air with the fragrance ends, the type of the fragrance, and/or a quantity of the fragrance depending on the situation-dependent fragrance settings. The computing unit can be configured according to the disclosure to influence or adjust the discharge device for mixing the first stream of air with the fragrance depending on the situation-dependent fragrance settings.

It is advantageous if the computing unit is configured to carry out a calculation of a target coordinate for an olfactory effect. It is particularly advantageous if the computing unit is configured to determine the target coordinate on the basis of a camera signal, a position of a face deduced from the camera signal, audio signals of a microphone array, a position of a face deduced from the audio signals of the microphone array, and/or a user input.

According to the disclosure, the computing unit can moreover be configured to influence or adjust an actuator such that the actuator directs the first stream of air and the second stream of air of the outlet element to the target coordinate. The computing unit can optionally be configured to adjust a flow rate of the first stream of air and/or the second stream of air depending on the target coordinate. It is moreover possible that the computing unit is configured to fix a start time, an end time, and/or a flow rate of the first and/or the second stream of air depending on the situation-dependent fragrance settings. The computing unit can be configured to influence or adjust the at least one air flow device for generating the first and/or the second stream of air accordingly and/or to regulate the flow rate of the first stream of air and/or the second stream of air in a different manner, for example by adjusting a valve.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for a directed emission of a fragrance, comprising:
mixing a first stream of air with the fragrance;
emitting the first stream of air from an outlet element; and
emitting a second stream of air, which is not mixed with the fragrance, in a form of a laminar flow from the outlet element, wherein the emission of the second stream of air takes place at the same time as the emission of the first stream of air, and wherein the second stream of air is emitted from the outlet element in an arrangement enclosing the first stream of air such that the second stream of air forms a laminar enveloping flow of the first stream of air after the emission from the outlet element.

2. The method according to claim 1, wherein the first stream of air is emitted from the outlet element in a direction of flow parallel to the second stream of air.

3. The method according to claim 1, wherein the second stream of air has, after the emission from the outlet element, a larger cross-sectional surface area, perpendicular to a direction of flow of the first stream of air and the second stream of air, than the first stream of air.

4. The method according to claim 1, wherein the emission of the first stream of air and the second stream of air takes place about a common center point.

5. The method according to claim 1, further comprising a process-controlled perfuming procedure which is triggered by at least one user input, a sensor or data value, and/or a request from a video game.

6. The method according to claim 5, wherein the sensor or data value is selected from the group consisting of an output value of an electronic nose, a camera signal, an audio signal, and a GPS signal.

7. The method according to claim 6, further comprising calculating situation-dependent fragrance settings on the basis of the at least one user input, the sensor or data value, the request from the video game, and/or on the basis of vehicle measurement data.

8. The method according to claim 7, wherein a point in time at which the mixing of the first stream of air with the fragrance begins, a point in time at which the mixing of the first stream of air with the fragrance ends, the type of the fragrance, and/or a quantity of the fragrance are fixed depending on the situation-dependent fragrance settings.

9. The method according to claim 1, further comprising calculation of a target coordinate for an olfactory effect.

10. The method according to claim 9, wherein the target coordinate is determined based on a camera signal, a position of a face deduced from the camera signal, audio signals of a microphone array, a position of a face deduced from the audio signals of the microphone array, and/or a user input.

11. The method according to claim 10, wherein an actuator acts on the outlet element such that the latter directs the first stream of air and the second stream of air to the target coordinate.

12. The method according to claim 11, wherein a flow rate of the first stream of air and/or the second stream of air is adjusted depending on the target coordinate.

13. The method according to claim 7, wherein a start time for generating the first stream of air and/or the second stream of air, an end time for generating the first stream of air and/or the second stream of air, and/or a flow rate of the first stream of air and/or the second stream of air are fixed depending on the situation-dependent fragrance settings.

14. The method according to claim 1, wherein the fragrance is emitted into a vehicle interior.

15. An outlet element for a directed emission of a fragrance, the outlet element comprising:
a first duct for the guidance of a first stream of air; and
a second duct for the guidance of a second stream of air, wherein the second duct has one or more air flow devices for generating a laminar flow, wherein the first duct forms a first opening for the issuing of the first stream of air, wherein the second duct forms a second opening for the issuing of the second stream of air, and wherein the second opening is arranged such that it surrounds the first opening.

16. The outlet element according to claim 15, wherein the first duct and the second duct are formed in a region immediately upstream of the first opening and the second opening such that the first stream of air is guided in a direction parallel to the second stream of air in the immediately upstream region.

17. The outlet element according to claim 16, wherein the first opening and the second opening are arranged about a common center point.

18. The outlet element according to claim 17, wherein the one or more air flow devices for generating the laminar flow are fins which are oriented parallel to a direction of flow of the second stream of air.

19. The outlet element according to claim 18, wherein a portion of the outlet element which has the first opening and the second opening is designed as movable such that an orientation of the first stream of air and the second stream of air can change.

20. A system for a directed emission of a fragrance, comprising:
at least one air flow device for generating a first steam of air and/or a second stream of air;
a discharge device for mixing the first stream of air with the fragrance; and
an outlet element comprising:
a first duct for the guidance of a first stream of air; and
a second duct for the guidance of a second stream of air, wherein the second duct has one or more air flow devices for generating a laminar flow, wherein the first duct forms a first opening for the issuing of the first stream of air, wherein the second duct forms a second opening for the issuing of the second stream of air, and wherein the second opening is arranged such that it surrounds the first opening.
